(19) United States
(12) Patent Application Publication
(10) Pub. No.: US 2025/0279935 A1
(43) Pub. Date: Sep. 4, 2025

(54) METHOD AND SYSTEM FOR INTELLIGENT SCHEDULING INTERNET OF THINGS DEVICES BASED ON BIG DATA

(71) Applicants: China Railway No. 4 Engineering Group Co., Ltd., Hefei City (CN); Anhui Shuzhi Construction Research Institute Co., Ltd., Hefei City (CN)

(72) Inventors: Lei Liu, Hefei City (CN); Heng Wang, Hefei City (CN); Liang Li, Hefei City (CN); Yuan Zhao, Hefei City (CN); Lei Wang, Hefei City (CN); Xiongfeng Bian, Hefei City (CN); Haowei Ma, Hefei City (CN); Aiming Hu, Hefei City (CN); Lina Xiao, Hefei City (CN)

(21) Appl. No.: 19/066,426

(22) Filed: Feb. 28, 2025

(30) Foreign Application Priority Data
Feb. 29, 2024 (CN) 202410223877.0

(51) Int. Cl. H04L 41/0896; G16Y 40/35

(52) U.S. Cl. CPC H04L 41/0896; G16Y 40/35

(57) ABSTRACT

A method and system for intelligent scheduling Internet of Things (IoT) devices, includes: determining whether an operation status of each IoT device meets a preset standard according to an average traffic; performing a secondary determination as to whether the operation status of the IoT devices meets the preset standard according to a change trend of the average traffic; according to a data volume of data to be transmitted of each IoT device and a priority of the IoT devices, determining in sequence whether to process the data to be transmitted of a single IoT device; determining to adjust a compression rate of the data to be transmitted to a corresponding value or adjust a data collection frequency of the IoT devices whose traffic within the preset detection period is greater than a preset traffic to a corresponding value; each IoT device continues to operate using current operation parameters.

### CROSS-REFERENCE TO RELATED APPLICATIONS

This application claims the priority and benefit of Chinese patent application No. 202410223877.0, filed on Feb. 29, 2024. The entirety of Chinese patent application No. 202410223877.0 is hereby incorporated by reference herein and made a part of this specification.

### TECHNICAL FIELD

The present disclosure relates to the technical field of Internet of Things, and in particular to a method and system for intelligent scheduling of Internet of Things devices based on big data.

### BACKGROUND ART

Internet of Things devices can connect to wireless networks, have data transmission capabilities, communicate and interact through the network, and be remotely controlled and maintained. The basic communication of Internet of Things devices relies on wireless sensor technology, which has higher performance requirements for mobile communications than traditional Internet technologies. Internet of Things devices include but are not limited to barcodes, radio frequency identification (RFID), sensors, global positioning systems (GPS), laser scanners and other information devices. These devices are connected to the Internet through agreed protocols to achieve intelligent identification, positioning, tracking, monitoring and management.

As Internet of Things technology continues to develop, the types of Internet of Things devices continue to increase, including various types of devices such as industry, smart home, water conservancy, electricity, etc. In Internet of Things, periodically reading status data from Internet of Things devices is an essential operation.

Chinese Patent Publication No.: CN117453365A, discloses a task scheduling method and a distributed task scheduling system for Internet of Things devices. The method includes: a kafka cluster module receives and stores to-be-scheduled task information carrying task execution time information from an Internet of Things platform; a kafka consumer instance obtains the to-be-scheduled task information from the kafka cluster module and sends it to a task scheduler instance; the task scheduler instance generates to-be-scheduled task information according to the task execution time information, and adds the to-be-scheduled task information to a lock-free task queue through a task enqueue interface; a task notification instance obtains the to-be-scheduled task information from the lock-free task queue through a task dequeue interface and sends it to at least one corresponding target Internet of Things device, so that each target Internet of Things device executes the task according to the to-be-scheduled task information. It can be seen that the existing technology has the following problems: it does not take into account the taking of corresponding processing measures for each Internet of Things device according to the operation conditions of each Internet of Things device, which affects the security of data transmission, and further affects the data transmission efficiency of the Internet of Things devices.

### SUMMARY

To this end, the present disclosure provides a method and system for intelligent scheduling Internet of Things devices based on big data, so as to overcome the problem that the existing fails to take corresponding processing measures for each Internet of Things device according to the operation conditions of each Internet of Things device, which affects the security of data transmission and further affects the data transmission efficiency of the Internet of Things devices.

As for one aspect, the present disclosure provides a method for intelligent scheduling of Internet of Things devices based on big data, including:
when a server obtains data transmitted by Internet of Things devices, determining whether an operation status of each Internet of Things device meets a preset standard according to an average traffic of each Internet of Things device obtained within a preset detection period;
when it is preliminarily determined that the operation status of each Internet of Things device does not meet the preset standard, performing a secondary determination as to whether the operation status of the Internet of Things devices meets the preset standard according to a change trend of the average traffic;
when it is preliminarily determined that the operation status of each Internet of Things device meets the preset standard, according to a data volume of data to be transmitted of each Internet of Things device and a priority of the Internet of Things devices, determining in sequence whether to process the data to be transmitted of a single Internet of Things device;
when it is determined that the operation status of each Internet of Things device does not meet the preset standard, determining to adjust a compression rate of the data to be transmitted to a corresponding value or adjust a data collection frequency of the Internet of Things devices whose traffic within the preset detection period is greater than a preset traffic to a corresponding value according to a variance of the traffic of each Internet of Things device;
when it is determined that the operation status of each Internet of Things device meets the preset standard, each Internet of Things device continues to operate using current operation parameters.

Furthermore, an analysis module determines whether the operation status of each Internet of Things device meets the preset standard according to the average traffic of each Internet of Things device obtained within the preset detection period, and when it is preliminarily determined that the operation status of each Internet of Things device does not meet the preset standard, performs the secondary determination as to whether the operation status of the Internet of Things devices meets the preset standard according to the change trend of the average traffic, or when it is determined that the operation status of each Internet of Things device does not meet the preset standard, determines a process mode for the data to be transmitted for the Internet of Things devices according to the variance of the traffic of each Internet of Things device, the traffic of the Internet of Things devices is a data volume sent or received by the Internet of Things devices.

Further, the analysis module draws a time-average traffic diagram B(t) according to each average traffic obtained within a preset evaluation period, and determines whether the operation status of each Internet of Things device meets the preset standard according to the slope of each time node in the calculated time-average traffic diagram B(t), when the analysis module preliminarily determines that the operation status of each Internet of Things device meets the preset standard, determines in sequence the process mode for each Internet of Things device according to the data volume of the data to be transmitted of each Internet of Things device and the priority of the Internet of Things device, or when it is determined that the operation status of each Internet of Things device does not meet the preset standard, determines the process mode for the data to be transmitted of the Internet of Things devices according to the variance of the traffic of each Internet of Things device.

Furthermore, the analysis module determines the process mode for each Internet of Things device in sequence according to the data volume of the data to be transmitted of each Internet of Things device and the priority of the Internet of Things device includes matching a single Internet of Things device with each server in sequence to process the data to be transmitted of a single Internet of Things device according to a matching result.

Furthermore, the analysis module matches a single Internet of Things device with each server in sequence to respectively calculate load requirements of the Internet of Things devices and the corresponding servers, and when the load requirements are less than or equal to an idle load ratio of the corresponding servers, matches an authority level of the Internet of Things devices with an authority level of the servers, and if the match is successful, controls the Internet of Things devices to transmit the data to be transmitted to the servers, and if the match is fault, determines to encrypt the data to be transmitted of the Internet of Things devices, and transmits the encrypted data to the servers;
when each load requirement is greater than the idle load ratio of each corresponding server, the analysis module divides the data to be transmitted into a plurality of data packets to transmit each data packet to a server matching the authority level of a single Internet of Things device;

Defining Li= [symbol] , with Di is the obtained data volume of the data to be transmitted by the i-th Internet of Things device, i=1, 2, 3 . . . , n, n is a total number of Internet of Things devices, Yj is the priority of the obtained corresponding Internet of Things device, j=1, 2, 3, 4, wherein the analysis module presets respectively corresponding priorities for the Internet of Things devices, comprising a first priority Y1=80, a second priority Y2=60, a third priority Y3=40 and a fourth priority Y4=20, α is a first preset parameter, defining α=0.7, β is a second preset parameter, defining β=0.3, Li is the load requirement of the i-th Internet of Things device, Zk is the data volume of the data to be transmitted by each Internet of Things device corresponding to a k-th server; the k-th server is the server corresponding to the i-th Internet of Things device, k=1, 2, 3 . . . m, m is the total number of the servers, F is a preset intervention parameter, defining F=0.45.

Furthermore, the analysis module is configured with a plurality of division adjustment modes for a division number of the data packets according to the obtained data volume of the data to be transmitted of a single Internet of Things device, and an adjustment range of the division number of the data packets by each division adjustment mode is different.

Furthermore, the analysis module determines a data processing mode for the Internet of Things devices according to the calculated variance of each traffic of each Internet of Things device within a preset detection period, including adjusting the compression rate of the data to be transmitted to a corresponding value according to the difference between a preset variance and the variance, or adjusting the data collection frequency of the Internet of Things devices whose traffic within the preset detection period is greater than the preset traffic to a corresponding value according to the difference between the variance and the preset variance.

Furthermore, the analysis module is configured with a plurality of compression adjustment modes for the compression rate of the data to be transmitted according to the calculated difference between the preset variance and the variance, and an adjustment range of the compression rate of the data to be transmitted by each compression adjustment mode is different.

Furthermore, the analysis module is configured with a plurality of collection adjustment modes for the data collection frequency of the corresponding Internet of Things devices according to the calculated difference between the variance and the preset variance, and an adjustment range of the data collection frequency of each collection adjustment mode for the Internet of Things devices whose traffic within the preset detection period is greater than the preset traffic is different.

As for another aspect, the present disclosure also provides a system for intelligent scheduling of Internet of Things devices using the above-mentioned method for intelligent scheduling of Internet of Things devices based on big data, including:
a data collection module includes a plurality of Internet of Things devices for collecting data,
a data transmission module includes a plurality of gateways correspondingly connected to each Internet of Things device to transmit data collected by the Internet of Things devices,
a cluster module includes a plurality of servers respectively connected to corresponding gateways for receiving data transmitted by the gateways,
the analysis module respectively connected to corresponding components in the data collection module, the data transmission module and the cluster module to determine whether the operation status of each Internet of Things device meets the preset standard according to the obtained average traffic of each Internet of Things device within the preset detection period, and, when it is preliminarily determined that the operation status of each Internet of Things device does not meet the preset standard, performing a secondary determination as to whether the operation status of the Internet of Things devices meets the preset standard according to the change trend of the average traffic.

Compared with the existing technology, the operation status of each Internet of Things device is specifically monitored according to the data volume actually processed by each Internet of Things device, and the average traffic of each Internet of Things device is obtained when the processed data volume is low, that is, when the average traffic is low, so that when the slope with a large number of nodes is large, that is, the average traffic gradually increases, the data to be transmitted gradually decreases. In this case, each server is recovering slowly. However, if there is an Internet of Things device with a sudden increase in data collection, it will cause abnormal data processing by the server. Therefore, the Internet of Things devices are monitored one by one. When the slope with a large number of nodes is too low, it is determined that the traffic of each Internet of Things device is too low, and the process mode for the corresponding Internet of Things device is specifically determined according to the distribution of the traffic of each Internet of Things device. While effectively improving the stability of the operation of the Internet of Things devices, the data transmission efficiency of the Internet of Things devices is further effectively improved.

Furthermore, when determined that the Internet of Things devices are monitored one by one, that is, when the slope with a large number of nodes is large, the analysis module promptly discovers abnormal Internet of Things devices, that is, Internet of Things devices with too much data to be transmitted due to collected excessive data volume, according to the situation between the data volume of the data to be transmitted of a single Internet of Things device and the data volume of the data to be transmitted of each Internet of Things device corresponding to the servers, and makes reference to the priority of the Internet of Things devices. When the priority is very low, even if the data volume of the data to be transmitted by the Internet of Things devices is too large, the servers can still slowly process a large data volume without affecting the processing of data transmitted by other Internet of Things devices. Comparing the obtained load requirement with the idle load ratio of the corresponding server, and each server runs stably when the slope with a large number of nodes is large. Evaluating the load requirement according to the idle load ratio, when the load requirement is less than the idle load ratio, it is determined that the server can process data for the Internet of Things device; when the load requirement is greater than the idle load ratio, it is determined that it is difficult for the servers to process a large data volume of the data to be transmitted, so that the data to be transmitted of a single Internet of Things device is processed. While effectively improving the security of data collected by the Internet of Things, the data transmission efficiency of the Internet of Things devices is further effectively improved.

Furthermore, when determined that the data to be transmitted of a single Internet of Things device is processed, the single Internet of Things device is matched with each server in sequence until a server whose load requirement is less than or equal to the idle load ratio of the corresponding server is matched, so that the Internet of Things devices can be allocated to the servers of the corresponding computing power according to the actual operation conditions of the Internet of Things devices, so as to effectively improve the process efficiency of the data collected from the Internet of Things device, and when the comparison between the Internet of Things devices and the servers is completed, the authority level of the Internet of Things devices is matched with the authority level of the servers. When the authority level of the Internet of Things devices and the authority level of the servers do not match correctly, there may be security risks. In order to protect the confidentiality and integrity of the data, and prevent unauthorized access and tampering, when each load requirement is greater than the idle load ratio of each corresponding server, each server cannot process the data to be transmitted of the Internet of Things devices. Therefore, the data to be transmitted is divided into a plurality of data packets, so as to transmit each data packet to the server matching the authority level of the single Internet of Things device respectively. While effectively improving the security of data collected by the Internet of Things, the data transmission efficiency of the Internet of Things devices is further effectively improved.

Furthermore, when determined that the traffic of each Internet of Things device is very low according to the calculated variance of each traffic of each Internet of Things device within a preset detection period. In this case, data transmission is abnormal due to poor network. Therefore, the compression rate of the data to be transmitted is increased to reduce the time required for data transmission and save bandwidth resources. When the variance is large, it is determined that there are abnormal Internet of Things devices, which affect the overall data transmission. In this case, a large number of Internet of Things devices are affected. Therefore, the data collection frequency of the abnormal Internet of Things devices is reduced to adjust the actual operation parameters of the Internet of Things devices according to the actual operation conditions of the Internet of Things devices. While effectively adapting the Internet of Things devices to the actual operation conditions, the data transmission efficiency of the Internet of Things devices is further effectively improved.

### BRIEF DESCRIPTION OF THE DRAWINGS

FIG. 1 is a flowchart of the method for intelligent scheduling of Internet of Things devices based on big data according to an embodiment of the present disclosure.

FIG. 2 is a block diagram of the system for intelligent scheduling Internet of Things devices based on big data according to an embodiment of the present disclosure.

FIG. 3 is a flowchart of a device determination mode in which the analysis module according to an embodiment of the present disclosure determines whether the operation status of each Internet of Things device meets a preset standard according to the average traffic.

FIG. 4 is a flowchart of a division adjustment mode in which the analysis module according to an embodiment of the present disclosure determines the division number of the data packets according to the obtained data volume of the data to be transmitted of a single Internet of Things device.

### DETAILED DESCRIPTION

In order to make the objects and advantages of the present disclosure more clearly understood, the present disclosure is further described below in conjunction with embodiments. It should be understood that the specific embodiments described herein are only used to explain the present disclosure and are not used to limit the present disclosure.

Preferred embodiments of the present disclosure will be described below with reference to the accompanying drawings. Those skilled in the art should understand that these implementations are only used to explain the technical principles of the present disclosure, and are not intended to limit the protection scope of the present disclosure.

It should be noted that, in the description of the present disclosure, the orientations or positional relationships indicated by the terms “upper”, “lower”, “left”, “right”, “inside”, “outside”, etc. are based on the orientations or positional relationships shown in the accompanying drawings, and are only for the convenience of description, rather than indicating or implying that the device or element must have a specific orientation, be constructed and operated in a specific orientation, and therefore cannot be understood as a limitation on the present disclosure.

In addition, it should be noted that in the description of the present disclosure, unless otherwise clearly specified and limited, the terms “installed”, “connection” and “connected” should be understood in a broad sense. For example, it can be a fixed connection, a detachable connection, or an integral connection. It can be a mechanical connection or an electrical connection. It can be a direct connection or an indirect connection through an intermediate medium, and it can be an internal communication of two elements. For those skilled in the art, the specific meanings of the above terms in the present disclosure can be understood according to specific circumstances.

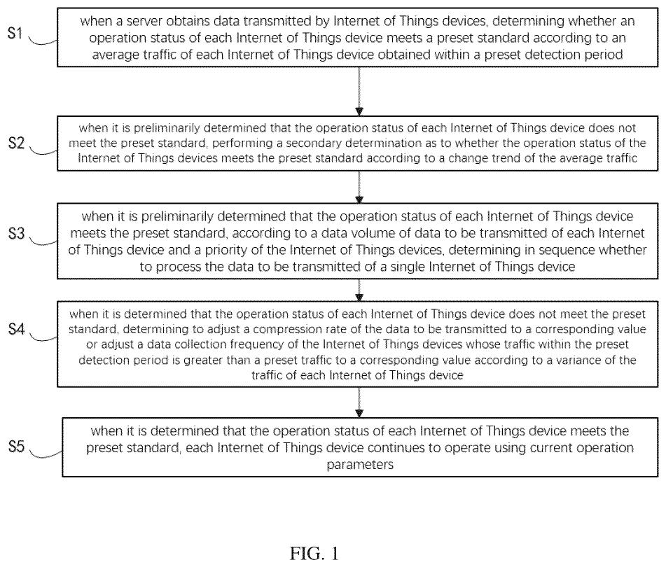

Referring to FIG. 1, which is a flowchart of the method for intelligent scheduling of Internet of Things devices based on big data according to an embodiment of the present disclosure. The method for intelligent scheduling of Internet of Things devices according to the present disclosure includes the following steps:
S1, when a server obtains data transmitted by Internet of Things devices, determining whether an operation status of each Internet of Things device meets a preset standard according to an average traffic of each Internet of Things device obtained within a preset detection period;
S2, when it is preliminarily determined that the operation status of each Internet of Things device does not meet the preset standard, performing a secondary determination as to whether the operation status of the Internet of Things devices meets the preset standard according to a change trend of the average traffic;
S3, when it is preliminarily determined that the operation status of each Internet of Things device meets the preset standard, according to a data volume of data to be transmitted of each Internet of Things device and a priority of the Internet of Things devices, determining in sequence whether to process the data to be transmitted of a single Internet of Things device;
S4, when it is determined that the operation status of each Internet of Things device does not meet the preset standard, determining to adjust a compression rate of the data to be transmitted to a corresponding value or adjust a data collection frequency of the Internet of Things devices whose traffic within the preset detection period is greater than a preset traffic to a corresponding value according to a variance of the traffic of each Internet of Things device;
S5, when it is determined that the operation status of each Internet of Things device meets the preset standard, each Internet of Things device continues to operate using current operation parameters.

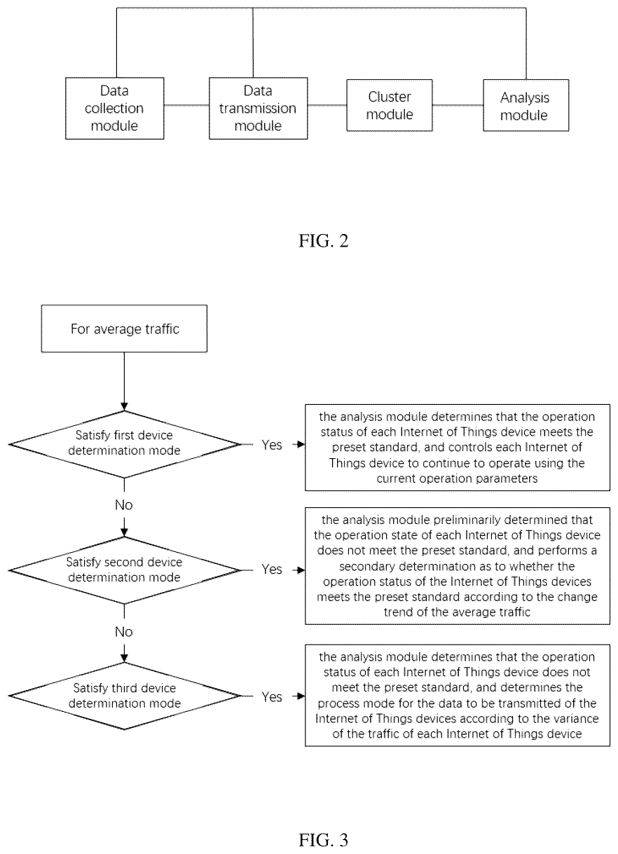

Referring to FIG. 2, which is a block diagram of the system for intelligent scheduling Internet of Things devices based on big data according to an embodiment of the present disclosure. The system for intelligent scheduling Internet of Things devices according to the present disclosure includes:
a data collection module includes a plurality of Internet of Things devices for collecting data,
a data transmission module includes a plurality of gateways correspondingly connected to each Internet of Things device to transmit data collected by the Internet of Things devices,
a cluster module includes a plurality of servers respectively connected to corresponding gateways for receiving data transmitted by the gateways,
the analysis module respectively connected to corresponding components in the data collection module, the data transmission module and the cluster module to determine whether the operation status of each Internet of Things device meets the preset standard according to the obtained average traffic of each Internet of Things device within the preset detection period, and, when it is preliminarily determined that the operation status of each Internet of Things device does not meet the preset standard, performing a secondary determination as to whether the operation status of the Internet of Things devices meets the preset standard according to the change trend of the average traffic.

Referring to FIG. 3, which is the flowchart of a device determination mode in which the analysis module according to an embodiment of the present disclosure determines whether the operation status of each Internet of Things device meets a preset standard according to the average traffic. When a server obtains data transmitted by Internet of Things devices, the analysis module of the disclosure obtains the average traffic of each Internet of Things device obtained within a preset detection period, and determines the device determination mode for whether the operation status of each Internet of Things device meets the preset standard according to the average traffic. In particular:
the first device determination mode is that the analysis module determines that the operation status of each Internet of Things device meets the preset standard, and controls each Internet of Things device to continue to operate using the current operation parameters. The first device determination mode satisfies that the average traffic is greater than the second preset average traffic;
the second device determination mode is that the analysis module preliminarily determined that the operation state of each Internet of Things device does not meet the preset standard, and performs a secondary determination as to whether the operation status of the Internet of Things devices meets the preset standard according to the change trend of the average traffic. The second device determination mode satisfies that the average traffic is less than or equal to the second preset average traffic and greater than the first preset average traffic, and the first preset average traffic is less than the second preset average traffic;
the third device determination mode is that the analysis module determines that the operation status of each Internet of Things device does not meet the preset standard, and determines the process mode for the data to be transmitted of the Internet of Things devices according to the variance of the traffic of each Internet of Things device. The third device determination mode satisfies that the average traffic is less than or equal to the first preset average traffic;
the traffic of the Internet of Things devices is the data volume sent or received by the Internet of Things devices.

In particular, the first preset average traffic is 60 KB/s, and the second preset average traffic is 251 KB/s.

Specifically, the analysis module draws a time-average traffic diagram B(t) according to each average traffic obtained within a preset evaluation period under the second device determination mode, and determines a secondary device determination mode for whether the operation status of each Internet of Things device meets the preset standard according to the slope of each time node in the calculated time-average traffic diagram B(t). In particular:
the first secondary device determination mode is that the analysis module preliminarily determines that the operation status of each Internet of Things device meets the preset standard, and determines the process mode for each Internet of Things device in sequence according to the data volume of the data to be transmitted by each Internet of Things device and the priority of the Internet of Things devices. The first secondary device determination mode satisfies that a ratio of the number of first calibration nodes to the total number of nodes in the time-average traffic diagram B(t) is greater than a preset quantity ratio. The first calibration nodes are nodes whose slope is greater than a second preset slope among all nodes;
the second secondary device determination mode is that the analysis module determines that the operation status of each Internet of Things device meets the preset standard, and controls each Internet of Things device to continue to operate using the current operation parameters. The second secondary device determination mode satisfies that a ratio of the number of second calibration nodes to the total number of nodes in the time-average traffic diagram B(t) is greater than the preset quantity ratio. The second calibration nodes are nodes with a slope greater than a first preset slope and less than or equal to the second preset slope among all nodes;
the third secondary device determination mode is that the analysis module determines that the operation status of each Internet of Things device does not meet the preset standard, and determines the process mode for the data of the Internet of Things devices according to the variance of the traffic of each Internet of Things device. The third secondary device determination mode satisfies that a ratio of the number of third calibrated nodes to the total number of nodes in the time-average traffic diagram B(t) is greater than the preset quantity ratio. The third calibration nodes are nodes whose slope is less than or equal to the first preset slope among all nodes.

In particular, the preset quantity ratio is 0.62.

The operation status of each Internet of Things device is specifically monitored according to the data volume actually processed by each Internet of Things device, and the average traffic of each Internet of Things device is obtained when the processed data volume is low, that is, when the average traffic is low, so that when the slope with a large number of nodes is large, that is, the average traffic gradually increases, and the data to be transmitted gradually decreases when the processed data volume is low. In this case, each server is recovering slowly. However, if there is an Internet of Things device with a sudden increase in data collection, it will cause abnormal data processing by the server. Therefore, the Internet of Things devices are monitored one by one. While effectively improving the stability of the operation of the Internet of Things devices, the data transmission efficiency of the Internet of Things devices is further effectively improved.

Specifically, the analysis module respectively calculates the load requirement Li for each

$$\frac{α \times Di + β \times Yj}{Zk} - F$$

Internet of Things device in the first secondary device determination mode of the first device, defining Li= [symbol] , with Di is the obtained data volume of the data to be transmitted by the i-th Internet of Things device, i=1, 2, 3 . . . , n, n is a total number of Internet of Things devices, Yj is the priority of the obtained corresponding Internet of Things device, j=1, 2, 3, 4, wherein the analysis module presets respectively corresponding priorities for the Internet of Things devices, comprising a first priority Y1=80, a second priority Y2=60, a third priority Y3=40 and a fourth priority Y4=20, α is a first preset parameter, defining α=0.7, β is a second preset parameter, defining β=0.3, Li is the load requirement of the i-th Internet of Things device, Zk is the data volume of the data to be transmitted by each Internet of Things device corresponding to a k-th server; the k-th server is the server corresponding to the i-th Internet of Things device, k=1, 2, 3 . . . m, m is the total number of the servers, F is a preset intervention parameter, defining F=0.45;

The analysis module determines a process mode for the i-th Internet of Things device according to the obtained the load requirement for the i-th Internet of Things device. In particular:
the first process mode is that the analysis module controls a single Internet of Things device to continue to operate using the current operation parameters. The first process mode satisfies that the load requirement of the i-th Internet of Things device is less than or equal to the idle load ratio of the corresponding server;
the second process mode is that the analysis module matches a single Internet of Things device with each server in sequence to process the data to be transmitted of the single Internet of Things device according to the matching result. The second process mode satisfies that the load requirement of the i-th Internet of Things device is greater than the idle load ratio of the corresponding server;
in particular, the idle load ratio is the ratio of the available disk space to the total disk space in the server.

When determined that the Internet of Things devices are monitored one by one, that is, when the slope with a large number of nodes is large, the analysis module promptly discovers abnormal Internet of Things devices, that is, Internet of Things devices with too much data to be transmitted due to collected excessive data volume, according to the situation between the data volume of the data to be transmitted of a single Internet of Things device and the data volume of the data to be transmitted of each Internet of Things device corresponding to the servers, and makes reference to the priority of the Internet of Things devices. When the priority is very low, even if the data volume of the data to be transmitted by the Internet of Things devices is too large, the servers can still slowly process a large data volume without affecting the processing of data transmitted by other Internet of Things devices. Comparing the obtained load requirement with the idle load ratio of the corresponding server, and each server runs stably when the slope with a large number of nodes is large. Evaluating the load requirement according to the idle load ratio, when the load requirement is less than the idle load ratio, it is determined that the server can process data for the Internet of Things device; when the load requirement is greater than the idle load ratio, it is determined that it is difficult for the servers to process a large data volume of the data to be transmitted, so that the data to be transmitted of a single Internet of Things device is processed. While effectively improving the security of data collected by the Internet of Things, the data transmission efficiency of the Internet of Things devices is further effectively improved.

Specifically, the analysis module under the second process mode matches a single Internet of Things device with each server in sequence to respectively calculate load requirements of the Internet of Things devices and the corresponding servers, and when the load requirements are less than or equal to an idle load ratio of the corresponding servers, matches an authority level of the Internet of Things devices with an authority level of the servers, and if the match is successful, controls the Internet of Things devices to transmit the data to be transmitted to the servers, and if the match is fault, determines to encrypt the data to be transmitted of the Internet of Things devices, and transmits the encrypted data to the servers;

When each load requirement is greater than the idle load ratio of each corresponding server, the analysis module divides the data to be transmitted into a plurality of data packets to transmit each data packet to a server matching the authority level of a single Internet of Things device.

When determined that the data to be transmitted of a single Internet of Things device is processed, the single Internet of Things device is matched with each server in sequence until a server whose load requirement is less than or equal to the idle load ratio of the corresponding server is matched, so that the Internet of Things devices can be allocated to the servers of the corresponding computing power according to the actual operation conditions of the Internet of Things devices, so as to effectively improve the process efficiency of the data collected from the Internet of Things device, and when the comparison between the Internet of Things devices and the servers is completed, the authority level of the Internet of Things devices is matched with the authority level of the servers. When the authority level of the Internet of Things devices and the authority level of the servers do not match correctly, there may be security risks. In order to protect the confidentiality and integrity of the data, and prevent unauthorized access and tampering, when each load requirement is greater than the idle load ratio of each corresponding server, each server cannot process the data to be transmitted of the Internet of Things devices. Therefore, the data to be transmitted is divided into a plurality of data packets, so as to transmit each data packet to the server matching the authority level of the single Internet of Things device respectively. While effectively improving the security of data collected by the Internet of Things, the data transmission efficiency of the Internet of Things devices is further effectively improved.

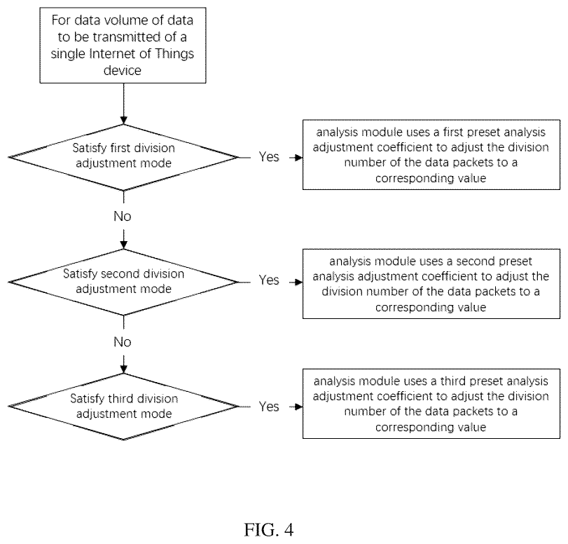

Referring to FIG. 4, which is a flowchart of a division adjustment mode in which the analysis module according to an embodiment of the present disclosure determines the division number of the data packets according to the obtained data volume of the data to be transmitted of a single Internet of Things device. The analysis module in the disclosure determines the division adjustment mode of the division number of the data packets according to the obtained data volume of the data to be transmitted of a single Internet of Things device. In particular:
the first division adjustment mode is that the analysis module uses a first preset analysis adjustment coefficient to adjust the division number of the data packets to a corresponding value. The first division adjustment mode satisfies that the data volume of the data to be transmitted by a single Internet of Things device is less than or equal to a first preset data volume;
the second division adjustment mode is that the analysis module uses a second preset analysis adjustment coefficient to adjust the division number of the data packets to a corresponding value. The second division adjustment mode satisfies that the data volume of the data to be transmitted by a single Internet of Things device is less than or equal to a second preset data volume and greater than the first preset data volume, and the first preset data volume is less than the second preset data volume;
the third division adjustment mode is that the analysis module uses a third preset analysis adjustment coefficient to adjust the division number of the data packets to a corresponding value. The third division adjustment mode satisfies that the data volume of the data to be transmitted by a single Internet of Things device is greater than the second preset data volume.

In particular, the first preset data volume is 1720 KB, the second preset data volume is 2100 KB, the first preset analysis adjustment coefficient is 1.1, the second preset analysis adjustment coefficient is 1.21, and the third preset analysis adjustment coefficient is 1.27.

Specifically, the analysis module determines the data processing mode for the Internet of Things devices according to the calculated variance of each traffic of each Internet of Things device within the preset detection period. In particular:
the first data processing mode is that the analysis module adjusts the compression rate of the data to be transmitted to a corresponding value according to the difference between the preset variance and the variance. The first data process mode satisfies that the variance is less than or equal to the preset variance;
the second data processing mode is that the analysis module adjusts the data collection frequency of the Internet of Things devices whose traffic within the preset detection period is greater than the preset traffic to a corresponding value according to the difference between the variance and the preset variance. The second data process mode satisfies that the variance is greater than the preset variance.

In particular, the preset variance is 580.

When determined that the traffic of each Internet of Things device is very low according to the calculated variance of each traffic of each Internet of Things device within a preset detection period. In this case, data transmission is abnormal due to poor network. Therefore, the compression rate of the data to be transmitted is increased to reduce the time required for data transmission and save bandwidth resources. When the variance is large, it is determined that there are abnormal Internet of Things devices, which affect the overall data transmission. In this case, a large number of Internet of Things devices are affected. Therefore, the data collection frequency of the abnormal Internet of Things devices is reduced to adjust the actual operation parameters of the Internet of Things devices according to the actual operation conditions of the Internet of Things devices. While effectively adapting the Internet of Things devices to the actual operation conditions, the data transmission efficiency of the Internet of Things devices is further effectively improved.

Specifically, the analysis module records the calculated difference between the preset variance and the variance as a lower first-level difference under the first data processing mode, and determines a compression adjustment mode for the compression rate of the data to be transmitted according to the obtained lower first-level difference. In particular:
the first compression adjustment mode is that the analysis module uses a first preset compression adjustment coefficient to adjust the compression rate of the data to be transmitted to a corresponding value. The first compression adjustment mode satisfies that the lower first-level difference is less than or equal to a first preset lower first-level difference;
the second compression adjustment mode is that the analysis module uses a second preset compression adjustment coefficient to adjust the compression rate of the data to be transmitted to a corresponding value. The second compression adjustment mode satisfies that the lower first-level difference is less than or equal to a second preset lower first-level difference and greater than the first preset lower first-level difference, and the first preset lower first-level difference is less than the second preset lower first-level difference;
the third compression adjustment mode is that the analysis module uses a third preset compression adjustment coefficient to adjust the compression rate of the data to be transmitted to a corresponding value. The third compression adjustment mode satisfies that the lower first-level difference is greater than the second preset lower first-level difference;

In particular, the first preset lower first-level difference is 120, the second preset lower first-level difference is 200, the first preset compression adjustment coefficient is 1.1, the second preset compression adjustment coefficient is 1.2, and the third preset compression adjustment coefficient is 1.3.

The analysis module determines a standard adjustment mode for a qth preset compression adjustment coefficient for a single Internet of Things device according to the data volume of the data to be transmitted by the single Internet of Things device, where q=1, 2, 3. In particular:
the first standard adjustment mode is that the analysis module uses a first preset standard adjustment coefficient to adjust the qth preset compression adjustment coefficient to a corresponding value. The first standard adjustment mode satisfies that the data volume of the data to be transmitted by a single Internet of Things device is less than or equal to a first preset calibration data volume;
the second standard adjustment mode is that the analysis module uses a second preset standard adjustment coefficient to adjust the qth preset compression adjustment coefficient to a corresponding value. The second standard adjustment mode satisfies that the data volume of the data to be transmitted by a single Internet of Things device is less than or equal to a second preset calibration data volume and greater than the first preset calibration data volume, and the first preset calibration data volume is less than the second preset calibration data volume;
the third standard adjustment mode is that the analysis module uses a third preset standard adjustment coefficient to adjust the qth preset compression adjustment coefficient to a corresponding value. The third standard adjustment mode satisfies that the data volume of the data to be transmitted by a single Internet of Things device is greater than the second preset calibration data volume.

In particular, the first preset calibration data volume is 1800 KB, the second preset calibration data volume is 2400 KB, the first preset standard adjustment coefficient is 0.92, the second preset standard adjustment coefficient is 0.95, and the third preset standard adjustment coefficient is 0.98.

Specifically, the analysis module records the calculated difference between the variance and the preset variance as a high second-level difference under the second data processing mode, and the analysis module determines the collection adjustment mode for the data collection frequency of the corresponding Internet of Things device according to the obtained high second-level difference. In particular:
the first collection adjustment mode is that the analysis module uses a first preset collection adjustment coefficient to adjust the data collection frequency of the Internet of Things devices whose traffic within the preset detection period is greater than the preset traffic to a corresponding value. The first collection adjustment mode satisfies that the high second-level difference is less than or equal to a first preset high second-level difference;
the second collection adjustment mode is that the analysis module uses a second preset collection adjustment coefficient to adjust the data collection frequency of the Internet of Things devices whose traffic within the preset detection period is greater than the preset traffic to a corresponding value. The second collection adjustment mode satisfies that the high second-level difference is less than or equal to a second preset high second-level difference and greater than the first preset high second-level difference, and the first preset high second-level difference is less than the second preset high second-level difference;
the third collection adjustment mode is that the analysis module uses a third preset collection adjustment coefficient to adjust the data collection frequency of the Internet of Things devices whose traffic within the preset detection period is greater than the preset traffic to a corresponding value. The third collection adjustment mode satisfies that the high second-level difference is greater than the second preset high second-level difference.

In particular, the first preset high second-level difference is 110, the second preset high second-level difference is 222, the first preset collection adjustment coefficient is 0.94, the second preset collection adjustment coefficient is 0.9, and the third preset collection adjustment coefficient is 0.85.

So far, the technical solution of the present disclosure has been described in conjunction with the preferred embodiments shown in the drawings. However, it is easy for those skilled in the art to understand that the protection scope of the present disclosure is obviously not limited to these specific embodiments. Without departing from the principles of the present disclosure, those skilled in the art may make equivalent changes or substitutions to the relevant technical features, and the technical solutions after these changes or substitutions will fall within the protection scope of the present disclosure.

The above description is only a preferred embodiment of the present disclosure and is not intended to limit the present disclosure. For those skilled in the art, the present disclosure may have various modifications and changes. Any modifications, equivalent substitutions, improvements, etc. made within the spirit and principle of the present disclosure should be included in the protection scope of the present disclosure.

What is claimed is:

1. A method for intelligent scheduling of Internet of Things devices, comprising
when a server obtains data transmitted by the Internet of Things devices, determining whether an operation status of each of the Internet of Things devices meets a preset standard according to an average traffic of each of the Internet of Things devices obtained within a preset detection period;
when it is preliminarily determined that the operation status of each of the Internet of Things devices does not meet the preset standard, performing a secondary determination as to whether the operation status of the Internet of Things devices meets the preset standard according to a change trend of the average traffic;
when it is preliminarily determined that the operation status of each of the Internet of Things devices meets the preset standard, according to a data volume of data to be transmitted of each of the Internet of Things devices and a priority of the Internet of Things devices, determining in sequence whether to process the data to be transmitted of a single Internet of Things device of the Internet of Things devices;
when it is determined that the operation status of each of the Internet of Things devices does not meet the preset standard, determining to adjust a compression rate of the data to be transmitted to a corresponding value or adjust a data collection frequency of the Internet of Things devices whose traffic within the preset detection period is greater than a preset traffic to a corresponding value according to a variance of the traffic of each of the Internet of Things devices; and
when it is determined that the operation status of each of the Internet of Things devices meets the preset standard, each of the Internet of Things devices continues to operate using current operation parameters.

2. The method for intelligent scheduling of Internet of Things devices according to claim 1, wherein an analysis module determines whether the operation status of each of the Internet of Things devices meets the preset standard according to the average traffic of each of the Internet of Things devices obtained within the preset detection period, and when it is preliminarily determined that the operation status of each of the Internet of Things devices does not meet the preset standard, the analysis module performs the secondary determination as to whether the operation status of the Internet of Things devices meets the preset standard according to the change trend of the average traffic, or when it is determined that the operation status of each of the Internet of Things devices does not meet the preset standard, the analysis module determines a process mode for the data to be transmitted for the Internet of Things devices according to the variance of the traffic of each of the Internet of Things devices, the traffic of the Internet of Things devices is a data volume sent or received by the Internet of Things devices.

3. The method for intelligent scheduling of Internet of Things devices according to claim 2, wherein the analysis module draws a time-average traffic diagram B (t) according to each average traffic obtained within a preset evaluation period, and the analysis module determines whether the operation status of each of the Internet of Things devices meets the preset standard according to a slope of each time node in the time-average traffic diagram B (t), when the analysis module preliminarily determines that the operation status of each of the Internet of Things devices meets the preset standard, the analysis module determines in sequence the process mode for the data to be transmitted for the Internet of Things devices according to the data volume of the data to be transmitted of each of the Internet of Things devices and the priority of the Internet of Things devices, or when it is determined that the operation status of each of the Internet of Things devices does not meet the preset standard, the analysis module determines the process mode for the data to be transmitted of the Internet of Things devices according to the variance of the traffic of each of the Internet of Things devices.

4. The method for intelligent scheduling of Internet of Things devices according to claim 3, wherein the analysis module determines the process mode for each of the Internet of Things devices in sequence according to the data volume of the data to be transmitted of each of the Internet of Things devices and the priority of the Internet of Things devices comprises matching a single Internet of Things device with each server in sequence to process the data to be transmitted of the single Internet of Things device according to a matching result.

5. The method for intelligent scheduling of Internet of Things devices according to claim 4, wherein the analysis module matches the single Internet of Things device with each server in sequence to respectively calculate load requirements of the Internet of Things devices and the corresponding servers, and when the load requirements are less than or equal to an idle load ratio of the corresponding servers, the analysis module matches an authority level of the Internet of Things devices with an authority level of the servers, and when the match is successful, controls the Internet of Things devices to transmit the data to be transmitted to the servers, and when the match is a fault, determines to encrypt the data to be transmitted of the Internet of Things devices to obtain encrypted data, and transmits the encrypted data to the servers;
when each of the load requirements is greater than the idle load ratio of each corresponding server, the analysis module divides the data to be transmitted into a plurality of data packets to transmit each of the plurality of data packets to a server matching the authority level of the single Internet of Things device;
defining
$$Li = \frac{α \times Di + β \times Yj}{Zk} - F ,$$
wherein Di is the data volume of the data to be transmitted by an i-th Internet of Things device, i=1, 2, 3 . . . , n, n is a total number of the Internet of Things devices, Yj is the priority of an obtained corresponding Internet of Things device, j=1, 2, 3, 4, wherein the analysis module presets respectively corresponding priorities for the Internet of Things devices, comprising a first priority Y1=80, a second priority Y2=60, a third priority Y3=40 and a fourth priority Y4=20, α is a first preset parameter, defining α=0.7, β is a second preset parameter, defining β=0.3, Li is a load requirement of the i-th Internet of Things device, Zk is the data volume of the data to be transmitted by each of the Internet of Things devices corresponding to a k-th server; the k-th server is a server corresponding to the i-th Internet of Things device, k=1, 2, 3 . . . m, m is a total number of the servers, F is a preset intervention parameter, defining F=0.45.

6. The method for intelligent scheduling of Internet of Things devices according to claim 5, wherein the analysis module is configured with a plurality of division adjustment modes for a division number of the plurality of data packets according to the data volume of the data to be transmitted of the single Internet of Things device, and an adjustment range of the division number of the plurality of data packets by each division adjustment mode is different.

7. The method for intelligent scheduling of Internet of Things devices according to claim 6, wherein the analysis module determines a data processing mode for the Internet of Things devices according to the variance of each traffic of each of the Internet of Things devices within the preset detection period, comprising adjusting the compression rate of the data to be transmitted to a corresponding value according to a difference between a preset variance and the variance, or adjusting the data collection frequency of the Internet of Things devices whose traffic within the preset detection period is greater than the preset traffic to a corresponding value according to a difference between the variance and the preset variance.

8. The method for intelligent scheduling of Internet of Things devices according to claim 7, wherein the analysis module is configured with a plurality of compression adjustment modes for the compression rate of the data to be transmitted according to the difference between the preset variance and the variance, and an adjustment range of the compression rate of the data to be transmitted by each of the plurality of compression adjustment modes is different.

9. The method for intelligent scheduling of Internet of Things devices according to claim 8, wherein the analysis module is configured with a plurality of collection adjustment modes for the data collection frequency of the corresponding Internet of Things devices according to the difference between the variance and the preset variance, and an adjustment range of the data collection frequency of each of the plurality of collection adjustment modes for the Internet of Things devices whose traffic within the preset detection period is greater than the preset traffic is different.

10. A system for intelligent scheduling of Internet of Things devices using the method for intelligent scheduling of Internet of Things devices according to claim 1, comprising:
a data collection module comprising a plurality of the Internet of Things devices for collecting the data,
a data transmission module comprising a plurality of gateways correspondingly connected to each of the plurality of the Internet of Things devices to transmit the data collected by the plurality of the Internet of Things devices,
a cluster module comprising a plurality of servers respectively connected to corresponding gateways of the plurality of gateways for receiving the data transmitted by the plurality of gateways, and
an analysis module respectively connected to corresponding components in the data collection module, the data transmission module and the cluster module to determine whether the operation status of each of the plurality of the Internet of Things devices meets the preset standard according to the average traffic of each of the plurality of the Internet of Things devices within the preset detection period, and, when it is preliminarily determined that the operation status of each of the plurality of the Internet of Things devices does not meet the preset standard, performing the secondary determination as to whether the operation status of the plurality of the Internet of Things devices meets the preset standard according to the change trend of the average traffic.
